(19) United States
(12) Patent Application Publication
(10) Pub. No.: US 2018/0152392 A1
(43) Pub. Date: May 31, 2018

(54) HYBRID CLOUD MANAGEMENT

(71) Applicant: HEWLETT PACKARD ENTERPRISE DEVELOPMENT LP, Houston, TX (US)

(72) Inventors: Michael Reed, Palo Alto, CA (US); Chandra Kamalakantha, Plano, TX (US); Parag Doshi, Alpharetta, GA (US)

(21) Appl. No.: 15/578,321

(22) PCT Filed: Jul. 10, 2015
(86) PCT No.: PCT/US2015/039982

§ 371 Date: Nov. 30, 2017

(51) Int. Cl. H04L 12/911; G06F 9/455

(52) U.S. Cl. CPC H04L 47/783; G06Q 30/04; G06F 2009/45595; G06F 9/45558

(57) ABSTRACT

A hybrid cloud management system in a cloud environment having a more than one cloud platforms is described. The system includes a management interface, a cloud broker including cloud connectors, and a resource broker. The management interface facilitates user-selection of services including service models and deployment models for an internal cloud and an external cloud. The cloud broker is coupled to the management interface to provision and automate lifecycle use of selected services. The cloud connector enables interaction of the management interface with the external cloud through the cloud broker. The resource broker operably coupled to the cloud broker to manage a resource inventory of the internal cloud.

### BACKGROUND

Cloud computing is a model of service delivery for enabling convenient, on-demand network access to a shared pool of configurable computing resources that can be rapidly provisioned and released with token management effort or interaction with a provider of the service. Cloud computing allows a consumer to obtain processing resources, such as networks, network bandwidth, servers, processing memory, storage, applications, virtual machines, and services as a service on an elastic and sometimes impermanent basis. Several vendors are currently offering cloud services. Cloud services include infrastructure as a service, platform as a service, storage as a service, software as a service, business process as a service, and other services. These services use vendor-specific service request, access, and consumption models.

### BRIEF DESCRIPTION OF THE DRAWINGS

FIG. 1 is a schematic diagram illustrating an example cloud computing environment.

FIG. 2 is a schematic diagram illustrating an example hybrid cloud management system in the example cloud environment of FIG. 1.

FIG. 3 is a schematic diagram illustrating a management interface of the system of FIG. 2.

FIG. 4 is a block diagram illustrating a method of the system of FIG. 2.

FIG. 5 is a schematic diagram illustrating an example computing device that can be used to implement the system of FIG. 2 and perform the method of FIG. 4.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

A consumer of cloud computing services may desire or have its own data processing system resources, such as its own on-premises computer network or its own private cloud to address an anticipated workload. The consumer's system resources have a limited amount of processing capability that may not meet growing business demands or, at certain times, unanticipated or anticipated surges in workload may overwhelm the consumer's processing capability. At these times, the response time for applications running on the consumer's computer network may increase to undesirable levels or the computer network does not include the data processing resources to perform the workload. In order to address the changes in demand for processing resources, the consumer may want to upgrade or scale the computer network or simply acquire computing resources as a service on a temporary basis. Different types of service offerings may provide parts of the solution used to address the workload. In such circumstances, the consumer may enlist the services of another cloud in a hybrid cloud solution or provision specific infrastructure, platforms, or applications.

Cloud consumers struggle with the mountain of expertise, investment, and time requisite to order, test, and incorporate new capabilities in conjunction with existing private, public, and virtual-private clouds.

An example hybrid cloud management system to manage, control, and offer services for a set of cloud platforms in a cloud environment is described. Cloud platforms can include internal clouds, external clouds, or a combination of internal and external clouds. The system includes a management interface, a cloud broker including cloud connectors, and a resource broker. The management interface facilitates user-selection of services including service models and deployment models for internal clouds and the external clouds. The cloud broker is coupled to the management interface to provision and automate lifecycle use of selected services. The cloud connector enables interaction of the management interface with external clouds through the cloud broker. The resource broker operably coupled to the cloud broker to manage a resource inventory of internal clouds.

The hybrid cloud management system and methods described simplify otherwise highly complex cloud orders. The hybrid cloud management system provides building blocks with automation scripts for instantiating a cloud as well as orchestrating and automating lifecycle functions of cloud and hybrid cloud management including connecting networking functionalities, creating seed cloud, under clouds, and overclouds, managing storage networks, and performing other features. The hybrid cloud system, illustrated in greater detail below, enables multiple customizations, is highly flexible, and delivers fully automated managed private clouds of various types to suit current and anticipated workloads.

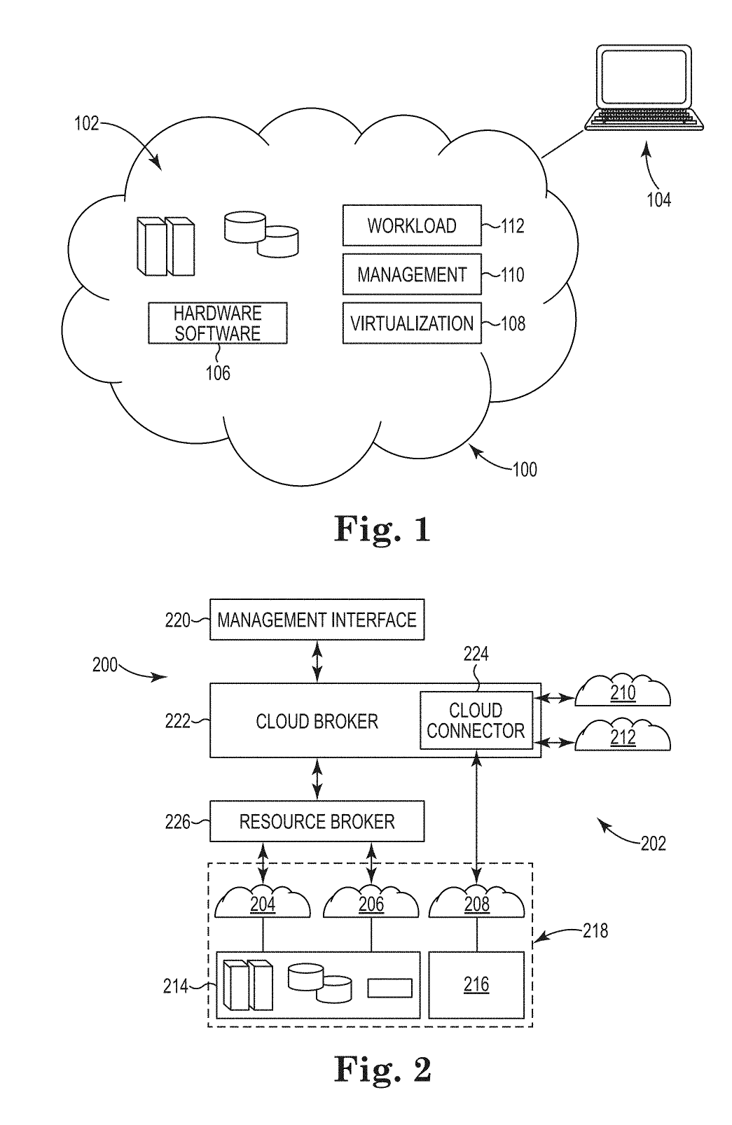

FIG. 1 illustrates an examples cloud computing environment 100 suitable for use with the hybrid cloud management system. Cloud computing environment 100 includes one or more interconnected cloud computing nodes 102 configured to communicate with local computing devices 104 such as personal computers, mobile devices, embedded systems, or other computing devices used by cloud consumers. Cloud computing environment 100 includes features such as statelessness, low coupling, modularity, and semantic interoperability. Cloud computing nodes 102 can be configured as computing devices including a processor, memory, storage, communication components, and software in the form of program modules stored in the memory. Cloud computing nodes 102 may be grouped physically or virtually in one or more networks or in one or more cloud deployment models. The cloud computing environment 100 offers services such as infrastructure, platforms, software, and business processes.

Cloud computing environment 100 can include a set of abstraction layers such as a hardware and software layer 106, virtualization layer 108, management layer 110, and workload layer 112. The hardware and software layer 106 includes hardware and software components such as servers, storage devices, networking and networking components, network application software, database software, and related software. The virtualization layer 108 provides virtualization entities such as virtual servers, storage, networks, and applications. The management layer 110 provides entities such as resource provisioning, metering and billing services for tracking and invoicing use, user portals for allowing cloud consumers and others access to the cloud computing environment 100, security, and service level management. Workload layer 112 provides functions such as mapping and navigation, software development and lifecycle management, data processing, and transaction processing. The components, layers, and other features of the cloud computing environment 100 are intended to be illustrative, and other example configurations are contemplated.

Cloud computing environment 100 is generally deployed in one or more recognized models. A private cloud deployment model includes an infrastructure operated solely for an organization whether it is managed internally or by a third-party and whether it is hosted on premises of the organization or some remote off-premises location. An example of a private cloud includes a self-run data center. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

A hybrid cloud is a deployment model that includes two or more clouds, such as private clouds, public clouds, and community clouds or combinations of two or more of each deployment model, that remain unique entities. Hybrid clouds include technology to bind together the two or more clouds, and in some examples permit data and application portability across clouds, such as cloud bursting for load balancing, and service interoperability.

Cloud computing providers generally offer services for the cloud computing environment as a service model including infrastructure as a service, platform as a service, software as a service, and other services. Infrastructure as a service providers offer the capability to provision processing, storage, networks, and other basic computing resources. The consumer generally does not manage the underlying cloud infrastructure, but generally retains control over the computing platform and applications that run on the platform. Platform as a service providers offer operating systems, execution runtimes, databases, and webservers, i.e., computing platforms. The consumer generally does not have control over the underlying infrastructure or computing platform, but can manage applications run on the platform. Software as a service providers offer software applications as a subscription service that are generally accessible from web browsers or other thin-client interfaces, and consumers do not load the applications on the local computing devices.

FIG. 2 illustrates an example hybrid cloud management system 200 configured to provide hybrid cloud solutions in the cloud environment 100. The cloud environment 100 includes a number of clouds platforms 202 deployed in various models, such as one or more internal clouds 204, 206, one or more other clouds such as virtual private clouds 208, and one or more external clouds 210, 212. In the example, internal clouds 204, 206 can be instantiated on resource pools, such as resource inventory 214, that can include one or more data centers or portions of data centers having compute, storage, or network facilities. Virtual private cloud 208 can be instantiated on a resource inventory 216 also having compute, storage, or network facilities. Additional or other clouds in the cloud environment 202 are contemplated, and the deployed clouds are illustrated for example to describe system 200.

Internal clouds 204, 206 can be configured and managed according to various types of platforms based on the specifications of the cloud consumer's workloads such as whether the workload is data intensive, compute intensive, storage intensive, or a combination of these or other specifications. For example, internal clouds 204, 206 can be configured and managed from a set of hardware, software, and service hosted in a private, public, community, or hybrid cloud in a platform available under the trade designation Helion from Hewlett-Packard of Palo Alto, Calif. In one example, cloud 204 can be a private cloud or hybrid cloud configured and managed from a service available under the trade designation Helion Eucalyptus, which is interoperable with a cloud computing platform available under the trade designation Amazon Web Services. Helion Eucalyptus can permit applications on Amazon Web Services to be readily transferred on-premises with relatively little or no modification to design pattern. In one example, dedicated cloud 206 can be a private or hybrid cloud configured and managed from a service available under the trade designation Helion OpenStack, which enables customers to deploy private, managed, hybrid, and public cloud services based on OpenStack technology.

External clouds 210, 212 include cloud platforms crossing service-provider ownership boundaries that may include other resource management functionalities than internal clouds 204, 206. External clouds 210, 212 can include private, public, community, or hybrid cloud platforms managed by third-parties or by service-providers not having management functionalities dedicated with system 200 or with internal clouds 204, 206 and other clouds 208. Other clouds, such as virtual private cloud 208, can be configured from within the service-provider ownership boundary 218 but may include other resource management functionalities than internal clouds 204, 206.

System 200 includes a management interface 220, cloud broker 222 including one or more cloud connectors 224, and one or more resource brokers 226. Management interface 220 is configured as an interface for cloud customers and others to order and perform lifecycle action steps on the cloud environment 202. For example, the management interface 220 facilitates user-selection of services including service models and deployment models for the one or more internal clouds 204, 206, the one or more external clouds 210, 212, and one or more other clouds such as virtual private cloud 208.

The cloud broker 222 is operably coupled to the management interface 220 and enables interactions across all clouds. For example, the cloud broker 222 can provision and automate lifecycle use of the selected services. Automating multiple use lifecycle cases includes billing and metering, quoting prices of services, deploying workloads, providing optimal workload management, cloud bursting or moving data processing workloads onto other platforms, and other services. The cloud connector 224 enables interaction of the management interface with the external clouds 210, 212 and other clouds 208.

The resource broker 226 is operably coupled to the cloud broker to manage the resource inventory 214 of the internal clouds 204, 206. In some examples, resource broker 226 could manage pools of resources in other cloud 208, but in some cases other cloud 208 includes its own inventory and resource management functionality and is coupled to the cloud broker 222 through cloud connector 224. Typically, the resource broker 226 does not manage external clouds 210, 212 because clouds of third-party service providers may include dissimilar resource management functionality and responsibilities. External clouds 210, 212 are then also coupled to the cloud broker 222 through cloud connectors 224.

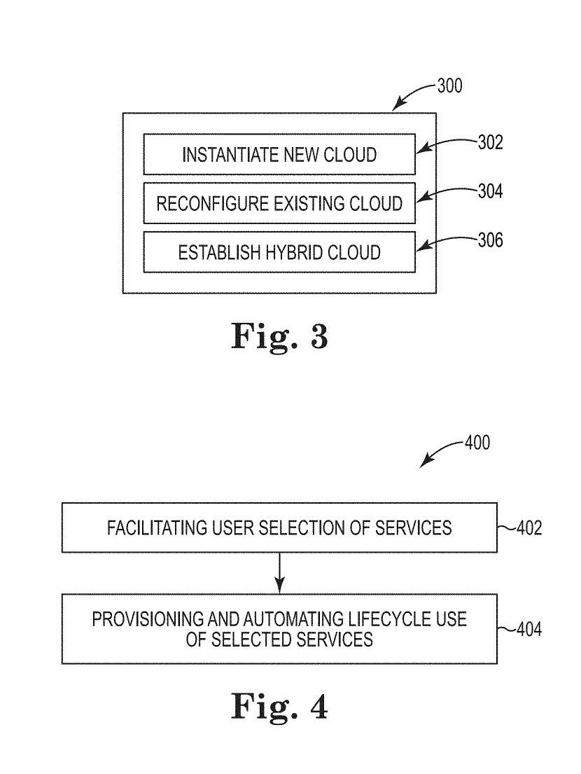

FIG. 3 illustrates an instance management interface 300, which is an example of management interface 220 of FIG. 2. Users can order or instantiate a new cloud of various types 302, reconfigure an existing cloud 304, or establish a hybrid cloud 306. For example, users can order a new cloud based on a Helion Eucalyptus or Helion OpenStack platforms, or other platforms (including other clouds and external clouds), scale up, scale down, or upgrade features of existing clouds, and establish network connections across disparate clouds. The management interface 300 simplifies otherwise extremely complex hybrid cloud orders in a unified module.

FIG. 4 illustrates an example method 400 of managing the hybrid cloud such as the cloud platforms 202 of FIG. 2. Method 400 includes facilitating user selection of services including instantiating new cloud, reconfiguring an existing cloud, and establishing a hybrid cloud at 402. In an example where method 400 is implement using a processor, facilitating user selection of services including instantiating new cloud, reconfiguring an existing cloud, and establishing a hybrid cloud can be performed through a management interface module. Method 400 includes provisioning and automating lifecycle use of selected services including managing a resource inventory of an internal cloud and enabling interaction with an external cloud at 404. In implementing 404 a processor, provisioning and automating lifecycle use of selected services can be performed with a cloud broker module, managing a resource inventory of a dedicated cloud can be performed through a resource broker module, and enabling interaction with an external cloud can be performed through a cloud connector module.

The hybrid cloud management system and method provides building blocks with automation scripts for instantiating a cloud as well as orchestrating and automating lifecycle functions of cloud and hybrid cloud management. This allows for quickly performing proof of concepts and testing prior to making further investments. In one example, the system and method provides for instantiation and configuration of clouds through seed, undercloud, and overcloud. The seed cloud is a bootable image that is deployed in a virtual machine instance. This image includes the bare services to function and to provision physical hardware to deploy the undercloud. The undercloud server is a basic single-node installation running on a single physical server used to deploy, test, manage, and update the overcloud servers. The overcloud is the functional cloud available to end users for running guest virtual machines and workloads. Users can reconfigure the hybrid clouds with different infrastructures, platforms, and software to optimize workload management on appropriate resource pools. Additionally, users can have direct access to application program interfaces (APIs), a set of routines, protocols, and tools for building applications and control plane for each environment while maintaining isolation to control the dedicated environment.

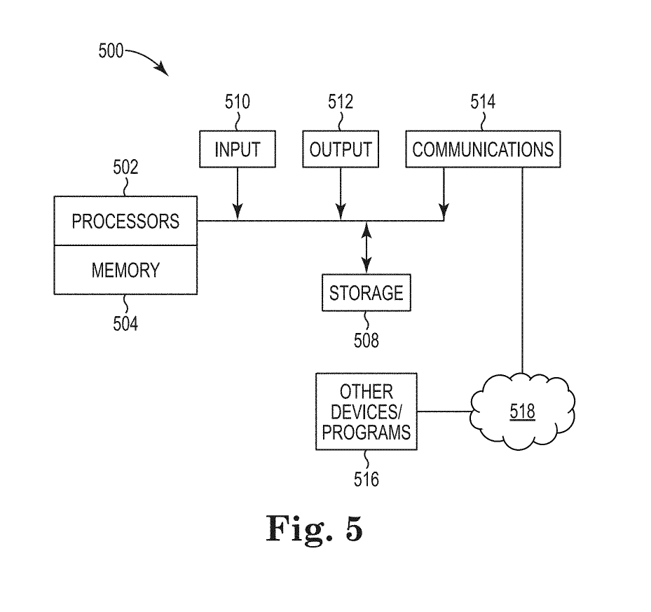

FIG. 5 illustrates an example computer system that can be employed in an operating environment and used to host or run a computer application implementing an example method 400 as included on one or more computer readable storage mediums storing computer executable instructions for controlling the computer system, such as a computing device, to perform a process. In one example, the computer system of FIG. 5 can be used to implement the modules and its associated tools set forth in system 200.

The exemplary computer system of FIG. 5 includes a computing device, such as computing device 500. Computing device 500 typically includes one or more processors 502 and memory 504. The processors 502 may include two or more processing cores on a chip or two or more processor chips. In some examples, the computing device 500 can also have one or more additional processing or specialized processors (not shown), such as a graphics processor for general-purpose computing on graphics processor units, to perform processing functions offloaded from the processor 502. Memory 504 may be arranged in a hierarchy and may include one or more levels of cache. Memory 504 may be volatile (such as random access memory (RAM)), non-volatile (such as read only memory (ROM), flash memory, etc.), or some combination of the two. The computing device 500 can take one or more of several forms. Such forms include a tablet, a personal computer, a workstation, a server, a handheld device, a consumer electronic device (such as a video game console or a digital video recorder), or other, and can be a stand-alone device or configured as part of a computer network, computer cluster, cloud services infrastructure, or other.

Computing device 500 may also include additional storage 508. Storage 508 may be removable and/or non-removable and can include magnetic or optical disks or solid-state memory, or flash storage devices. Computer storage media includes volatile and nonvolatile, removable and non-removable media implemented in any suitable method or technology for storage of information such as computer readable instructions, data structures, program modules or other data. A propagating signal by itself does not qualify as storage media.

Computing device 500 often includes one or more input and/or output connections, such as USB connections, display ports, proprietary connections, and others to connect to various devices to receive and/or provide inputs and outputs. Input devices 510 may include devices such as keyboard, pointing device (e.g., mouse), pen, voice input device, touch input device, or other. Output devices 512 may include devices such as a display, speakers, printer, or the like. Computing device 500 often includes one or more communication connections 514 that allow computing device 500 to communicate with other computers/applications 516. Example communication connections can include, but are not limited to, an Ethernet interface, a wireless interface, a bus interface, a storage area network interface, a proprietary interface. The communication connections can be used to couple the computing device 500 to a computer network 518, which is a collection of computing devices and possibly other devices interconnected by communications channels that facilitate communications and allows sharing of resources and information among interconnected devices. Examples of computer networks include a local area network, a wide area network, the Internet, or other network.

Computing device 500 can be configured to run an operating system software program and one or more computer applications, which make up a system platform. A computer application configured to execute on the computing device 500 is typically provided as set of instructions written in a programming language. A computer application configured to execute on the computing device 500 includes at least one computing process (or computing task), which is an executing program. Each computing process provides the computing resources to execute the program.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A hybrid cloud management system in a cloud environment including a plurality of cloud platforms, the system comprising:
a management interface to facilitate user-selection of services including service models and deployment models for the plurality of cloud platforms;
a cloud broker operably coupled to the management interface to provision and automate lifecycle use of selected services, the cloud broker including a cloud connector enabling interaction of the management interface with an external cloud; and
a resource broker operably coupled to the cloud broker to manage a resource inventory of an internal cloud.

2. The system of claim 1, wherein the service models include a plurality of infrastructure as a service, platform as a service, and software as a service.

3. The system of claim 1, wherein the deployment models include private clouds and public clouds.

4. The system of claim 1, wherein the services include instantiating new cloud, reconfiguring an existing cloud, and establishing a hybrid cloud.

5. The system of claim 4, wherein the instantiating and the reconfiguring include creating a seed cloud, an undercloud, and an overcloud.

6. The system of claim 4, wherein the reconfiguring the existing cloud includes upgrading cloud facilities.

7. The system of claim 1, wherein the automating lifecycle use includes deploying workloads, providing optimal workload management, and cloud bursting.

8. The system of claim 1, wherein the resource broker provides management functionalities within service-provider boundaries.

9. The system of claim 8, wherein the cloud environment includes a virtual private cloud operably within the service-provider boundary and coupled to the management interface through the cloud connector.

10. The system of claim 1, wherein the cloud environment includes a plurality of internal clouds and a plurality of external clouds.

11. A method of managing a cloud environment including a plurality of cloud platforms, the method comprising:
facilitating user selection of services including instantiating a new cloud, reconfiguring an existing cloud, and establishing a hybrid cloud; and
provisioning and automating lifecycle use of selected services including managing a resource inventory of an internal cloud and enabling interaction of the internal cloud with an external cloud.

12. The method of claim 11, wherein the automating lifecycle use includes billing, deploying workloads, providing optimal workload management, quoting prices for services, and cloud bursting.

13. A computer readable medium for storing computer executable instructions for controlling a computing device to perform a method for managing a hybrid cloud including a plurality of cloud platforms, the method comprising:
facilitating user selection of services including instantiating new cloud, reconfiguring an existing cloud, and establishing a hybrid cloud through a management interface; and
provisioning and automating lifecycle use of selected services including managing a resource inventory of an internal cloud through a resource broker and enabling interaction with an external cloud through a cloud connector.

14. The computer readable medium of claim 13, including a plurality of internal clouds within a service-provider boundary and coupled to the management interface through the resource broker.

15. The computer readable medium of claim 14, including a plurality of external clouds coupled to the management interface through the cloud connector.

16. The system of claim 1, wherein the user-selection of services is selected from the internal cloud, the external cloud, and a virtual private cloud.

17. The system of claim 5, wherein the seed cloud comprises a bootable image that is deployed in a virtual machine instance.

18. The system of claim 5, wherein the undercloud comprises a single-node installation running on a single server to deploy, test, manage, and update the overcloud.

19. The system of claim 1, wherein the internal cloud comprises a plurality of different internal clouds, wherein each one of the plurality of different internal clouds is interoperable with a different cloud platform of the plurality of cloud platforms.

20. The method of claim 11, wherein the facilitating is performed via a management interface that allows the user selection of services from the internal cloud, the external cloud, and a virtual private cloud.
